(19) United States
(12) Patent Application Publication
(10) Pub. No.: US 2025/0257786 A1
(43) Pub. Date: Aug. 14, 2025

(54) ISOLATORS FOR PANEL ASSEMBLIES AND OTHER STRUCTURES

(71) Applicant: The Boeing Company, Arlington, VA (US)

(72) Inventors: Terec Lloyd Morgan-Willson, Overland, MO (US); Steven F. Griffin, Kihei, HI (US)

(21) Appl. No.: 18/439,232

(22) Filed: Feb. 12, 2024

(51) Int. Cl. F16F 15/04

(52) U.S. Cl. CPC F16F 15/046

(57) ABSTRACT

Example isolators for panel assemblies and other structures are disclosed herein. An example apparatus disclose herein includes a panel, a frame, and an isolator coupling the panel and the frame, the isolator including a first flange including a first side coupled to the panel, and a second side opposite the first side, a second flange including a third side coupled to the frame, and a fourth side opposite the first side, and a flexible bellows positioned between the first flange and the second flange, the flexible bellows including a first end coupled to the second side, and a second end coupled to the fourth side.

### FIELD OF THE DISCLOSURE

This disclosure relates generally to isolation devices and, more particularly, to isolators for panel assemblies and other structures.

### BACKGROUND

Mechanical assemblies, such as aviation systems, include vibration-sensitive devices (e.g., optics, sensors, fragile components, passenger compartments, etc.), and/or devices that generate vibration and/or noise (e.g., powerplants, aerosurfaces, etc.). Elastomers, bushings, and other systems are used in such systems to damp vibration and prevent interference with vibration-sensitive components.

### BRIEF DESCRIPTION OF THE DRAWINGS

FIG. 1 is a perspective view of an example aviation system having an example panel assembly implemented in accordance with teachings of this disclosure.

FIG. 2 is a perspective view of the example panel assembly of FIG. 1 including an example flexible isolator disclosed herein.

FIG. 3A is a perspective view of the example flexible isolator of FIG. 2.

FIG. 3B is a cross-sectional view of the example flexible isolator of FIG. 2.

FIG. 4 is a cross-sectional view of the example panel assembly of FIG. 2.

FIG. 5A is a perspective view of an example first corner of the example flexible isolator of FIGS. 2-4.

FIG. 5B is a perspective view of an example second corner of the example flexible isolator of FIGS. 2-4.

FIG. 6A is a partial, perspective view of the example flexible isolator of FIG. 2 and an example first spring disclosed herein in an example first configuration.

FIG. 6B is a partial, perspective view of the example flexible isolator of FIG. 2 and the example first spring of FIG. 6A in an example second configuration.

FIG. 6C is a partial, perspective view of the example flexible isolator of FIG. 2 and the example first spring of FIG. 6A in an example third configuration.

FIG. 7A is a partial, perspective view of the example flexible isolator of FIG. 2 and an example second spring disclosed herein in an example first configuration.

FIG. 7B is a partial, perspective view of the example flexible isolator of FIG. 2 and the example second spring of FIG. 7A in an example second configuration.

FIG. 7C is a partial, perspective view of the example flexible isolator of FIG. 2 and the example second spring of FIG. 7A in an example third configuration.

FIG. 8A is a partial, first perspective view of the example flexible isolator of FIG. 2 including an example auxiliary seal disclosed herein disposed in an opening of the flexible isolator of FIG. 2.

FIG. 8B is a partial, second perspective view of the example flexible isolator of FIG. 8A.

FIG. 8C is a cross-sectional view of the example flexible isolator of FIG. 8A. FIG. 9 is a perspective view of an example aircraft including an example window panel assembly disclosed herein.

FIG. 10 is a perspective view of another example aircraft including a plurality of example panel assemblies disclosed herein.

In general, the same reference numbers will be used throughout the drawing(s) and accompanying written description to refer to the same or like parts. The figures are not necessarily to scale.

### DETAILED DESCRIPTION

Many mechanical assemblies include components that are sensitive to vibration, mechanical loads, deflection relative to adjacent components, and/or components that generate comparatively large amounts of loading, deflection, and/or vibration. For example, aviation systems can include panel assemblies that are sensitive to vibration, deflections, and/or loading associated with the operation of the aviation system. Such, aviation systems can include, but not limited to, window panel assemblies, door jamb panel assemblies, and/or electrical panel assemblies. To prevent damage to such sensitive components, assemblies can include isolators, which couple the panel assemblies to a main body or frame of the aviation system. The isolators isolate sensitive components from loading, vibration, and/or displacement (e.g., edge displacement).

One type of prior isolator is elastomer pucks (also referred to as elastomer pads). The elastomer pads can be used to damp vibrations and permit relative deflection between two or more components coupled via the elastomer pucks. However, such prior elastomer puck isolators permit a comparatively small amount of relative deflection before the elastomer pucks begin to transmit significant amounts of loading between the coupled components. Other types of prior isolators include wire rope isolators, which are typically capable of supporting greater amounts of deflections than elastomer puck isolators. However, wire rope based isolators require comparatively greater amounts of packaging space (e.g., integration volume, etc.) than elastomer puck isolators. Some space launch applications employ modified isolation systems that operate similarly to the wire rope system. Such modified isolation systems are similar to the wire rope systems but have unidirectional machined materials to improve control of the isolation direction and effective spring and dampening rates of the isolators. However, such modified isolation systems suffer similar integration volume issues as the wire rope systems. Additionally, none of the aforementioned prior isolators function as environmental seals. As such, prior isolators require additional seals to be used in aviation systems that require such environmental sealing.

Examples disclosed herein overcome the above-noted deficiencies and include isolators for panel assemblies that enable comparatively large deflections between the panel assemblies and a frame or parent structure to which the panel assembly is coupled. Additionally, example isolators disclosed herein provide a seal (e.g., a tight seal) between the panel assemblies and the frame and/or parent structure. Some example isolators disclosed herein include a first flange coupled to the panel assembly, a second flange coupled to the parent structure, and flexible bellows extending between the first flange and the second flange. In some such examples disclosed herein, the flexible bellows facilitates deflection of the panel assembly relative to the parent structure, damp vibrations transmitted therethrough, and provide a seal between the panel assembly and the parent structure (e.g., to seal an interior of the parent structure from an external environment of the parent structure, etc.). Example isolators disclosed herein enable isolation of multi-panel assemblies including panels disposed in multiple geometric planes. In some examples disclosed herein, a thickness, material composition, and/or geometry of the bellows can be selected or modified to tune or adjust a spring rate of the example isolator. Additionally, example isolators disclosed herein reduce overall system weight when compared to prior systems by mitigating the need for additional dedicated seals and/or reinforcement structures to compensate for loads caused by large deflections.

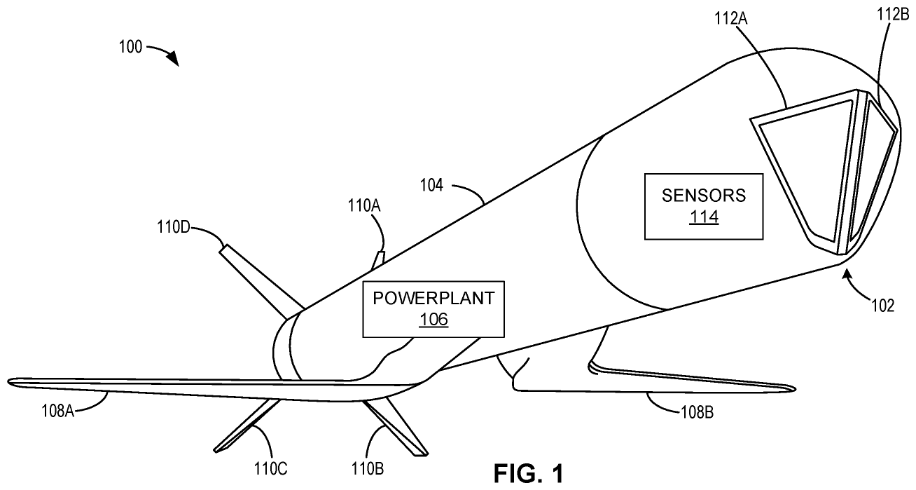

FIG. 1 is a perspective view of an example aviation system 100 including an example panel assembly 102 implemented in accordance with teachings of this disclosure. The aviation system 100 includes an example body 104, an example powerplant 106, an example first wing 108A, an example second wing 108B, an example first fin 110A, an example second fin 110B, an example third fin 110C, and an example fourth fin 110D. In the illustrated example of FIG. 1, the aviation system 100 is a cruise missile. In other examples, the aviation system 100 can include a fixed-wing aircraft (e.g., a military fixed-wing aircraft, a commercial fixed-wing aircraft, etc.), a rotary-wing aircraft (e.g., a helicopter, etc.), an aerostat (e.g., an airship, a weather balloon, etc.), an astronautical vehicle (e.g., a launch system, a spacecraft, a spaceplane, a satellite, etc.), an unmanned vehicle (e.g. a drone), and/or another type of weapon system (e.g., a ballistic missile, a tactical missile, etc.).

The panel assembly 102 includes an example first panel 112A and an example second panel 112B. In the illustrated example of FIG. 1, the panels 112A, 112B are windows. The panels 112A, 112B enable example sensors 114 to be housed within the body 104 and receive information transmitted through the panels 112A, 112B. For example, the sensors 114 can include one or more optical sensors and/or infrared (IR) sensors. Additionally or alternatively, the sensors 114 can include other sensors (e.g., other sensors associated with a guidance system of the aviation system 100, etc.). The panels 112A, 112B can be composed of reinforced glass, sapphire, and/or polyetherimide (PEI). In other examples, the panels 112A, 112B can be composed of any other suitable material(s) that permits sensor information to be received by the sensors 114.

In some examples, operation of the aviation system 100 can generate vibrations and/or loading on the components of the aviation system 100. For example, operation of the powerplant 106 can generate vibration (e.g., from friction within the powerplant 106, due to unbalancing within the powerplant 106, etc.) and/or reaction loading on the body 104 from thrust produced by the powerplant 106. In some examples, the powerplant 106 can be a gas turbine engine (e.g., a turbojet engine, etc.) and/or a rocket engine (e.g., a liquid rocket engine, a solid rocket engine, etc.). In some examples, the powerplant 106 is absent (e.g., the aviation system 100 is unpowered, etc.). Similarly, aero-loading (e.g., lift, drag, etc.) caused by the flow of air over the wings 108A, 108B, and/or the fins 110A, 110B, 110C, 110D can apply loads and/or cause vibrations of the body 104. In some examples, loading and vibration associated with the powerplant 106, the wings 108A, 108B, and/or the fins 110A, 110B, 110C, 110D can be transmitted from the body 104 to the panel assembly 102. The panels 112A, 112B of the illustrated example are sensitive to vibrations and/or loads associated with the body 104. For example, high amounts of vibrations and/or loads transmitted from the body 104 to the panel assembly 102 can cause the panels 112A, 112B to warp, crack, and/or otherwise be damaged.

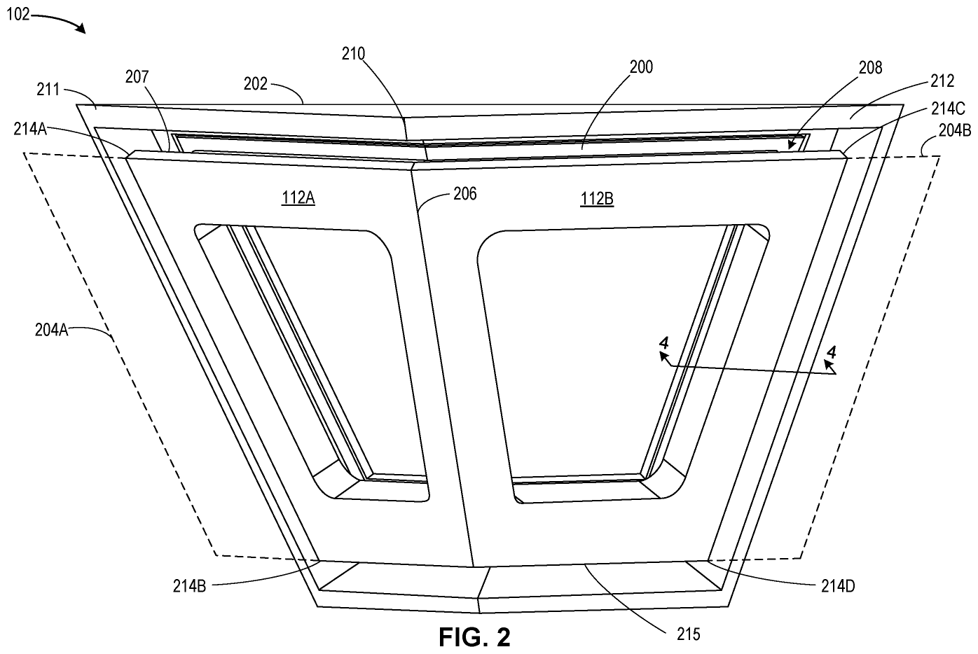

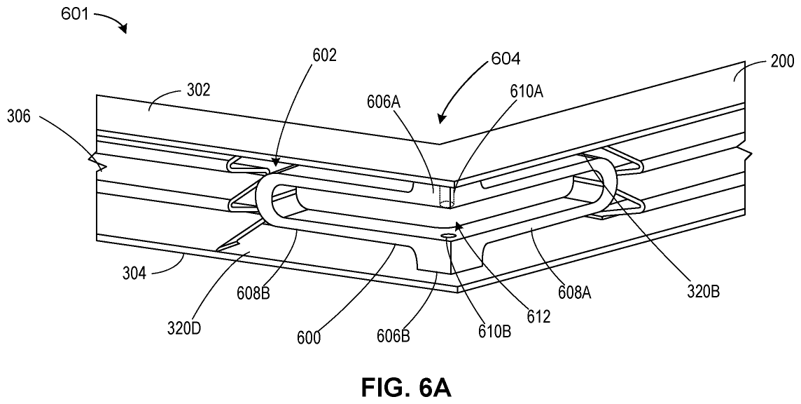

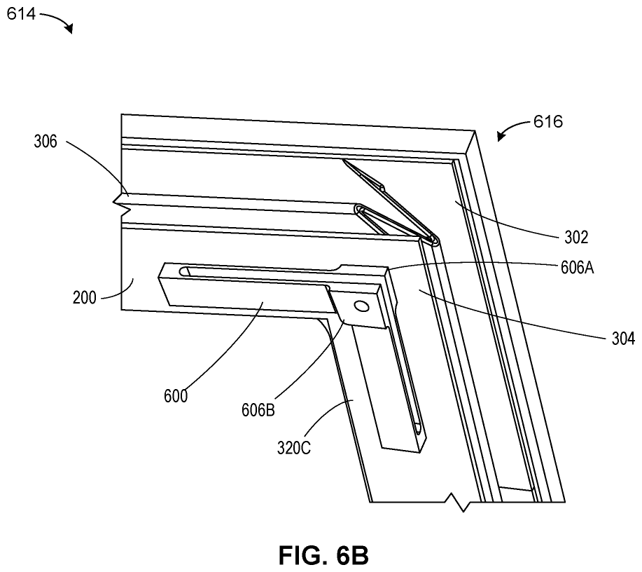

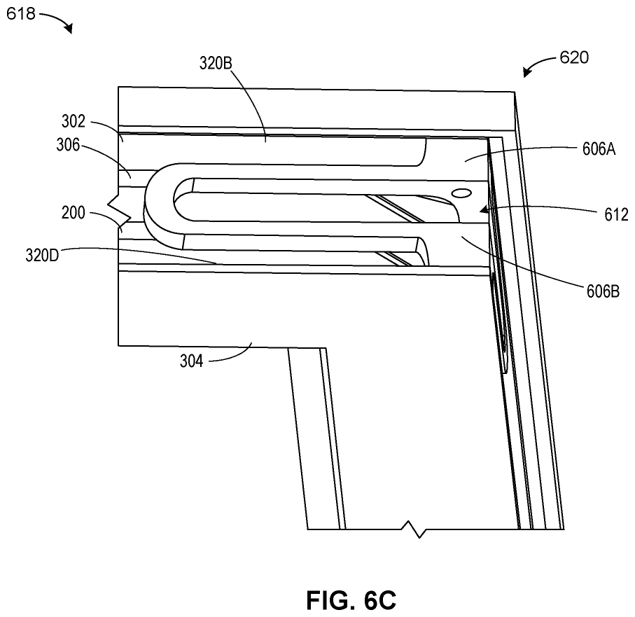

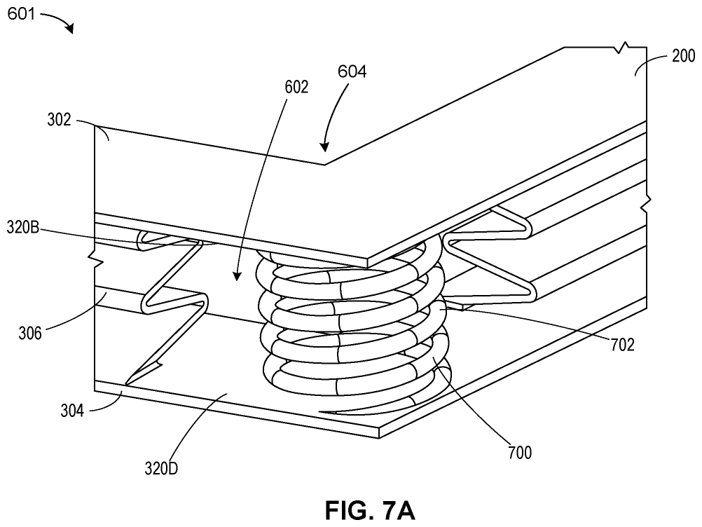

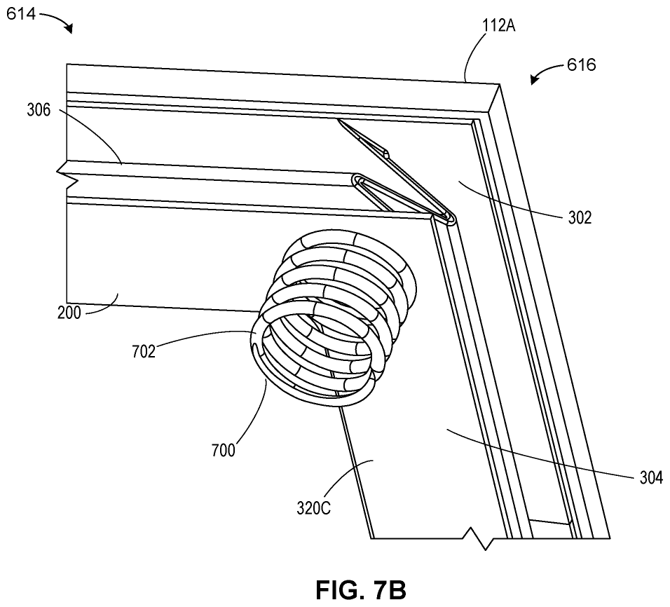

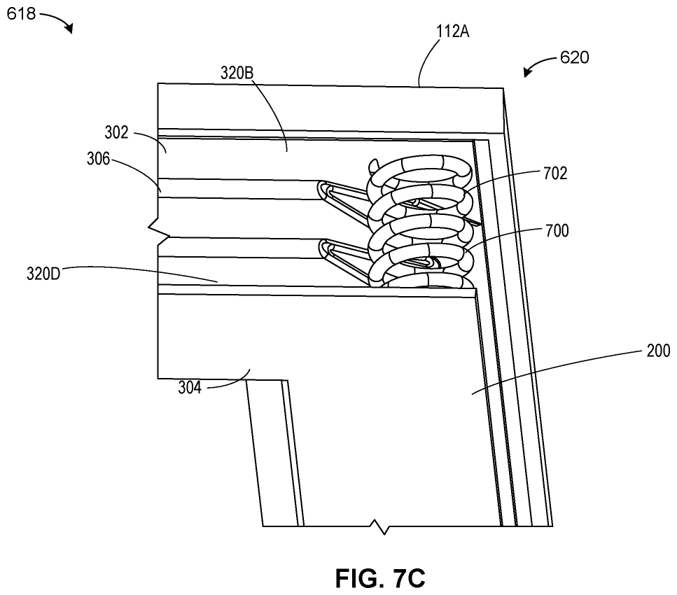

To mitigate such vibrations and/or loading, the aviation system 100 of the illustrated example employs the panel assembly 102. The panel assembly 102 of the illustrated example is structured or configured to damp vibrations transmitted from the body 104 and to deflect/deform from loading transmitted between the panel assembly 102 and the body 104 (e.g., to reduce the stress/strain bore by the panels 112A, 112B, etc.). The panel assembly 102 is described in further detail below in conjunction with FIGS. 2-5B. As described below, the example panel assembly 102 of the illustrated example isolates the panels 112A, 112B from such generated loads and/or vibrations. Aviation systems including panel assemblies similar to the panel assembly 102 of FIG. 2 are described below in conjunction with FIGS. 6 and 7.

FIG. 2 is a perspective view of the panel assembly 102 of FIG. 1. The panel assembly 102 of the illustrated example includes an example flexible isolator 200 disclosed herein. In the illustrated example of FIG. 2, the panel assembly 102 further includes the first panel 112A of FIG. 1, the second panel 112B of FIG. 1, and an example parent structure 202. The parent structure 202 of the illustrated example can be a frame, a beam, a housing, and/or any other structure(s). In the illustrated example of FIG. 2, the first panel 112A is disposed in an example first plane 204A (e.g., a first geometric plane, etc.), and the second panel 112B is disposed in an example second plane 204B (e.g., a second geometric plane, etc.). The first plane 204A of the illustrated example is different than the second plane 204B. For example, the first plane 204A is at an angle (e.g., an angle less than ninety degrees) relative to the second plane 204B. In the illustrated example of FIG. 2, the first panel 112A and the second panel 112B are coupled at an example panel joint 206 (e.g., a weld, etc.). The first panel 112A and the second panel 112B (e.g., collectively, etc.) define an example first perimeter 207. In the illustrated example of FIG. 2, the flexible isolator 200 forms an example interface 208 between the panels 112A, 112B, and the parent structure 202. In the illustrated example of FIG. 2, the parent structure 202 includes an example structure joint 210 (e.g., a weld) and an example structure lip 211. In the illustrated example of FIG. 2, the parent structure 202 defines an example second perimeter 212.

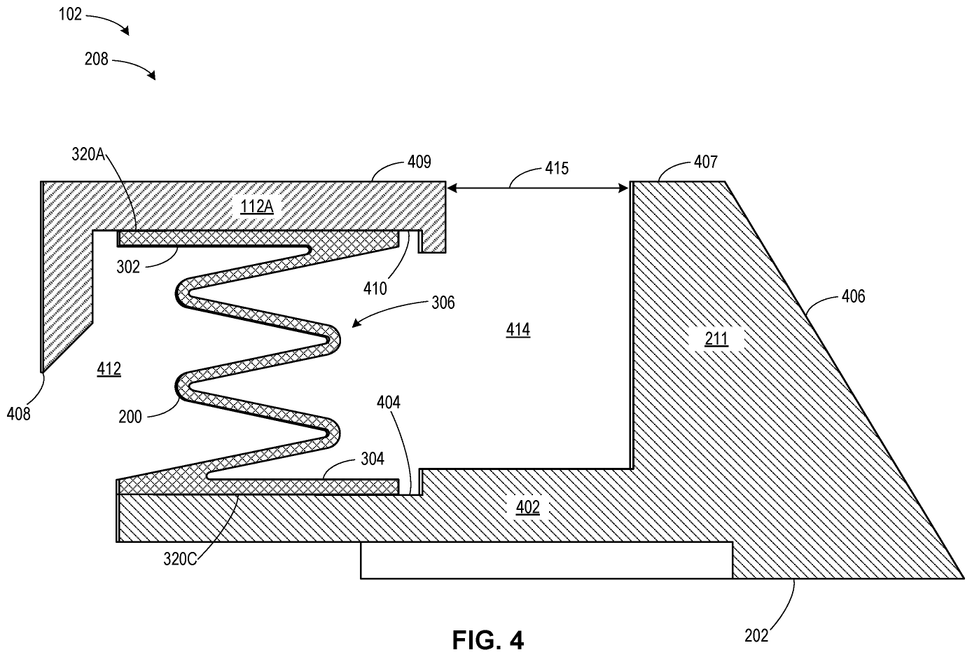

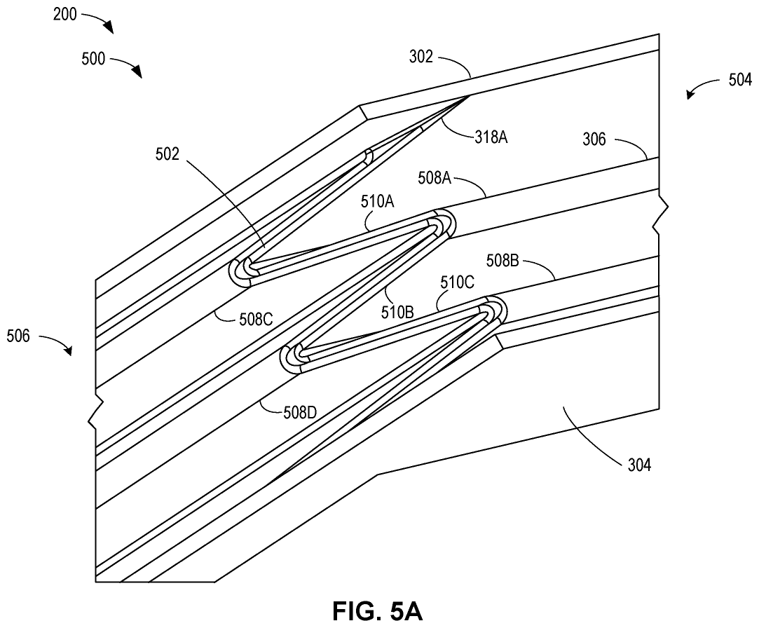

The parent structure 202 is the structure (e.g., a frame, etc.) to which the panels 112A, 112B are coupled. Specifically, in the illustrated example, the panels 112A, 112B are coupled to the parent structure 202 via the flexible isolator 200. For example, the parent structure 202 can be a component (e.g., a bulkhead, a frame, a beam, etc.) of the body 104 of the aviation system 100 of FIG. 1. In other examples, the parent structure 202 can be a discrete component that is rigidly coupled to the body 104 (e.g., via one or more fasteners, via one or more welds, etc.). The terms “parent structure” and “frame” are used interchangeably to refer to the parent structure 202. In the illustrated example of FIG. 2, the parent structure 202 includes the structure joint 210, which aligns with the panel joint 206 of the panels 112A, 112B. An example configuration of the parent structure 202 is described below in conjunction with FIG. 4.

In the illustrated example of FIG. 2, the panels 112A, 112B are not coplanar and are disposed in separate planes (e.g., the first plane 204A and the second plane 204B, respectively, etc.). That is, in the illustrated example of FIG. 2, the panel assembly 102 is a multi-planar assembly. In other examples, the second panel 112B is absent or is coplanar with the first panel 112A. In some such examples, the panel assembly 102 is a mono-planar assembly. An example aviation system including a plurality of mono-planar assemblies is described below in conjunction with FIG. 7. Additionally or alternatively, the panel assembly 102 can include additional panels (e.g., three panels, four panels, five panels, etc.). An example aviation system including a panel assembly having more than two panels is described below in conjunction with FIG. 6. In the illustrated example of FIG. 2, the panels 112A, 112B are a same size and are a same shape, which is mirrored across or relative to the panel joint 206. In other examples, the panels 112A, 112B can have different size(s), different shape(s), and/or any other suitable spatial relationship.

In the illustrated example of FIG. 2, the first panel 112A includes an example first panel corner 214A and an example second panel corner 214B. In the illustrated example of FIG. 2, the second panel 112B includes an example third panel corner 214C and an example fourth panel corner 214D. In the illustrated example of FIG. 2, the first perimeter 207 of the panels 112A, 112B extends along an interior of the panels 112A, 112B between the corners 214A, 214B, 214C, 214D adjacent to an example edge 215 of the panels 112A, 112B. In some examples, the panel assembly 102 can include one or more springs disposed in corresponding ones of the corners 214A, 214B, 214C, 214D. In some such examples, the springs disposed in ones of the corners 214A, 214B, 214C, 214D can be used to tune or adjust (e.g., increase) a local spring rate and/or damping rate of the panel assembly 102 at the corners 214A, 214B, 214C, 214D. Example springs that can be used in conjunction with flexible isolator 200 are described below in conjunction with FIGS. 6A-6C.

As noted above, the panels 112A, 112B of the illustrated example are coupled (e.g., joined) at the panel joint 206. The panel joint 206 is defined along a line at the intersection of the planes 204A, 204B. In some examples, the panels 112A, 112B are rigidly coupled at the panel joint 206 (e.g., via one or more fasteners, one or more welds, one or more interference fits, one or more chemical adhesives, etc.). Additionally or alternatively, the panels 112A, 112B can be coupled at the panel joint 206 via the individual coupling of the panels 112A, 112B to the flexible isolator 200. In other examples, the panels 112A, 112B are not rigidly coupled at the panel joint 206. In some such examples, the panel joint 206 can include one or more bushings and/or elastomers that enable the relative movement of the panels 112A, 112B. In some examples, the first panel 112A is decoupled from the second panel 112B. In some such examples, the first panel 112A is coupled to the flexible isolator 200 independently or separately from the second panel 112B.

The flexible isolator 200 couples the panels 112A, 112B to the parent structure 202. That is, the flexible isolator 200 forms the interface 208 with the parent structure 202, enables the relative deflection of the panels 112A, 112B and the parent structure 202, and damps vibrations associated with parent structure 202. In the illustrated example of FIG. 2, the flexible isolator 200 is omni-directionally flexible and facilitates the deflection of the panels 112A, 112B relative to the parent structure 202. That is, the flexible isolator 200 is elastically deformable and enables the relative deflection of the panels 112A, 112B within the planes 204A, 204B (e.g., toward the structure lip 211 of the parent structure 202 along the planes 204A, 204B, etc.), the relative deflection of the panels 112A, 112B toward the parent structure 202 (e.g., the compression of the flexible isolator 200, compressive strain of the flexible isolator 200, etc.), and/or the relative the deflection of the panels 112A, 112B away from the parent structure 202 (e.g., elongation of the flexible isolator 200, tensile strain of the flexible isolator 200, etc.). The movement of the panels 112A, 112B relative to the parent structure 202 can be laterally rectilinearly, vertically, diagonally, and/or any other direction.

In the illustrated example of FIG. 2, the flexible isolator 200 extends between the panels 112A, 112B (e.g., a surface of the panels 112A, 112B oriented toward the parent structure 202) and the parent structure 202 (e.g., a surface of the parent structure 202 oriented toward the panels 112A, 112B). For example, the flexible isolator 200 of the illustrated example extends between the first perimeter 207 of the panels 112A, 112B (e.g., an interior perimeter of the panels 112A, 112B, etc.) and the second perimeter 212 of the parent structure 202 (e.g., an exterior perimeter of the parent structure 202, etc.). In the illustrated example of FIG. 2, the flexible isolator 200 extends along an entirety of the perimeters 207, 212. In other examples, the flexible isolator 200 can be disposed at another location on the panels 112A, 112B (e.g., an interior of the panels 112A, 112B, etc.) and/or another location on the parent structure 202 (e.g., an interior of the parent structure 202, etc.).

In some examples, if the flexible isolator 200 does not include openings, the flexible isolator 200 seals an interior of the parent structure 202 from an exterior of the panels 112A, 112B (e.g., an external environment of the parent structure 202 and/or the aviation system 100). In some such examples, the flexible isolator 200 prevents gas flow, liquid flow, debris, and/or other gases, fluids or materials from passing through the panel assembly 102 into an interior of the aviation system 100 via the interface 208. Accordingly, in such examples, the flexible isolator 200 provides a seal for the interface 208 and mitigates the need for the interface 208 to include a separate seal. In other examples, the flexible isolator 200 can include one or more gaps and/or is only disposed on portions of the perimeters 207, 212. In some examples, the gaps can include one or more holes (e.g., circular holes, polygonal holes, etc.). Additionally or alternatively, the gaps can segment the flexible isolator 200 into a plurality of discrete segments (e.g., two discrete segments, three discrete segments, ten discrete segments, etc.) that are independently coupled to panels 112A, 112B and the parent structure 202. In some such examples, positioning of the gaps of the flexible isolator 200 can be determined to tune the flexibility (e.g., damping rate, elasticity, etc.) at portions along the perimeters 207, 212, and/or the damping rate of the flexible isolator 200. An example opening in the flexible isolator 200 is described below in conjunction with FIGS. 6A, 7A, and 8A-8C.

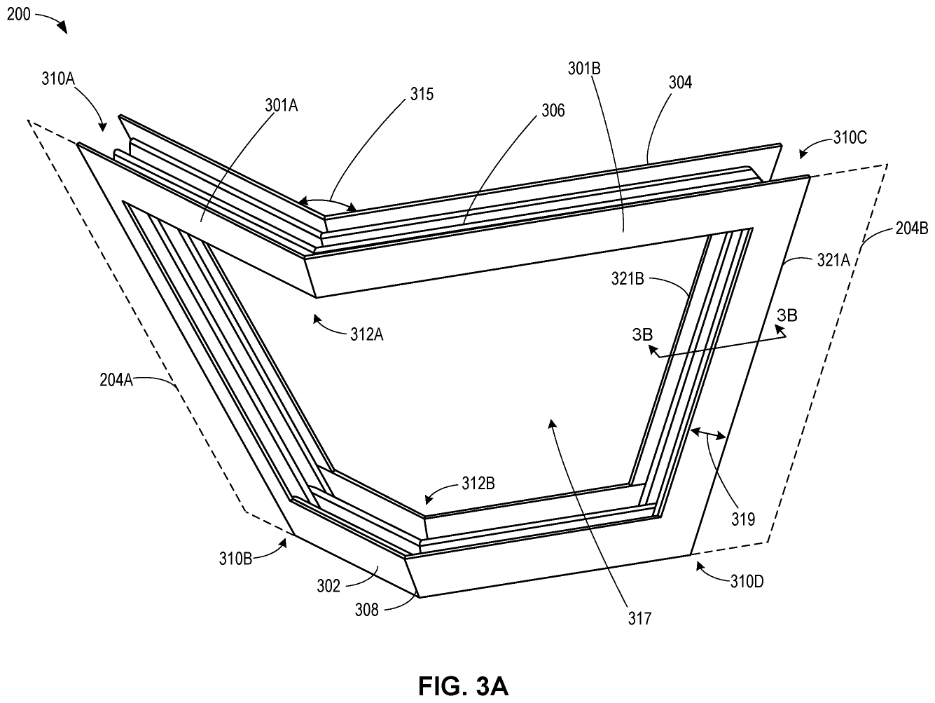

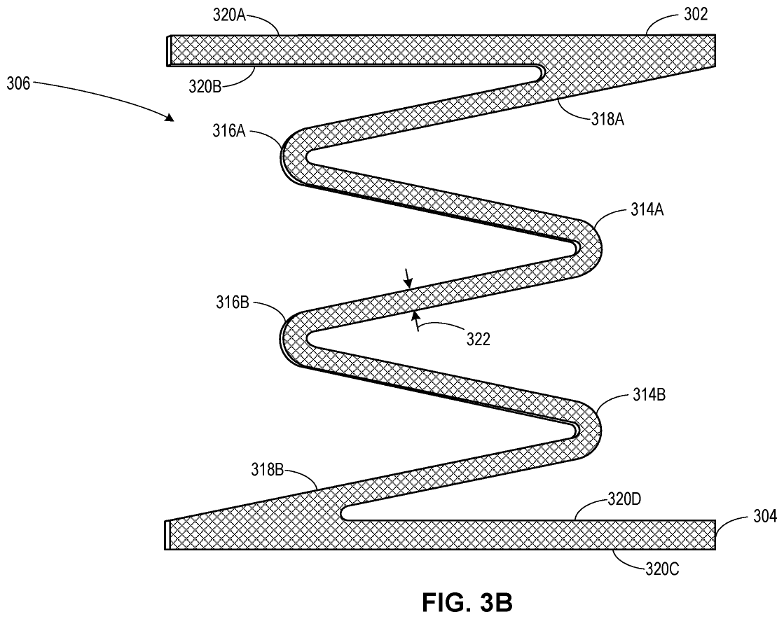

FIG. 3A is a perspective view of the flexible isolator 200 of FIG. 2. The flexible isolator 200 of the illustrated example includes an example first portion 301A and an example second portion 301B. In the illustrated example of FIG. 3A, the flexible isolator 200 includes an example first flange 302, an example second flange 304, and example bellows 306. In the illustrated example of FIG. 3A, the flexible isolator 200 includes an example first intraplanar corner 310A, an example second intraplanar corner 310B, an example third intraplanar corner 310C, and an example fourth intraplanar corner 310D. In the illustrated example of FIG. 3A, the flexible isolator 200 includes an example first interplanar corner 312A and an example second interplanar corner 312B, which are disposed at, or aligned with, an example joint 308.

In the illustrated example of FIG. 3A, the first portion 301A of the flexible isolator 200 aligns with or is disposed in the first plane 204A and the second portion 301B of the flexible isolator 200 aligns with or is disposed in the second plane 204B. In the panel assembly 102 of FIGS. 1 and 2, the first portion 301A is coupled to and abutting the first panel 112A and the second portion 301B is coupled to and abutting the second panel 112B. For example, the first intraplanar corner 310A can be aligned with the first panel corner 214A of FIG. 2, the second intraplanar corner 310B can be aligned with the second panel corner 214B of FIG. 2, the third intraplanar corner 310C can be aligned with the third panel corner 214C of FIG. 2, and the fourth intraplanar corner 310D can be aligned with the fourth panel corner 214D of FIG. 2. In the illustrated example of FIG. 3A, the interplanar corner 312A, 312B are disposed at, or align with, the joint 308 (e.g., a longitudinal axis of the joint 308). In some examples, the interplanar corners 312A, 312B and the joint 308 can be aligned with the panel joint 206 of the panels 112A, 112B of FIG. 2. In some such examples, the joint 308 is coupled to and/or abutting the panel joint 206.

In other examples, if the panel assembly 102 includes additional panels, the flexible isolator 200 can include additional portions that correspond to the additional panels. In the illustrated example of FIG. 3A, the first portion 301A and the second portion 301B of the flexible isolator 200 are integral components. In other examples, the first portion 301A and the second portion 301B can be coupled via one or more fasteners, one or more welds, one or more chemical adhesives, and/or any other suitable fastener(s). In the illustrated example of FIG. 3A, the portions 301A, 301B form an example internal angle 315 relative to the joint 308. In the illustrated example of FIG. 3A, the internal angle 315 is less than 180 degrees (e.g., between 25 degrees and 70 degrees). In other examples, the internal angle 315 can be greater than 180 degrees.

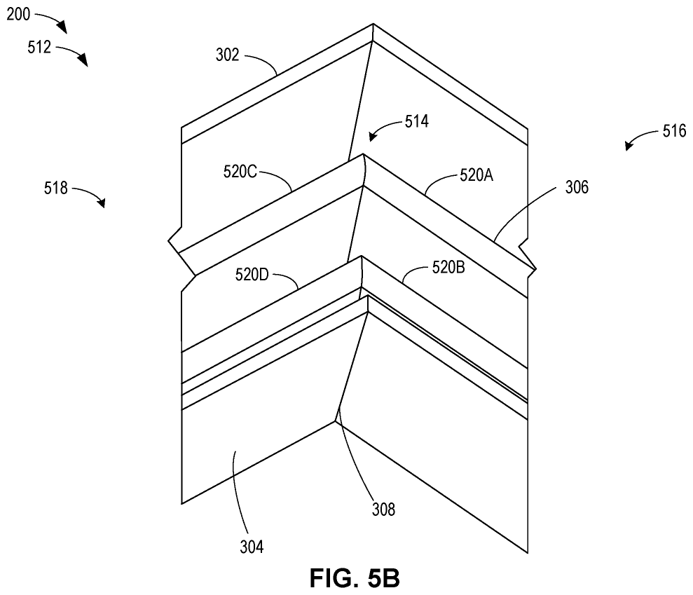

The intraplanar corners 310A, 310B, 310C, 310D are the corners of the flexible isolator 200 that are disposed entirely within a single or first common plane (e.g., the intraplanar corners 310A, 310B, 310C, 310D are in-plane corners, are located in a same plane, a first vertical plane, etc.). For example, the first intraplanar corner 310A and the second intraplanar corner 310B associated with the first portion 301A and the third intraplanar corner 310C and the fourth intraplanar corner 310D associated with the second portion 301B fall within a common plane (e.g., a vertical plane) taken through the corners 310A-310D (i.e., taken through all four corners), and the first interplanar corner 312A and the second interplanar corner 312B are positioned outside of this common plane in which the corners 310A-310D are located. An example implementation of the intraplanar corners 310A, 310B, 310C, 310D are described below in conjunction with FIG. 5A.

The interplanar corners 312A, 312B are corners of the flexible isolator 200 transition the first plane 204A and the second plane 204B. That is, the interplanar corners 312A, 312B are formed between the first portion 301A and the second portion 301B. Thus, the first plane 204A and the second plane 204B share the interplanar corners 312A, 312B. The interplanar corners 312A and 312B are located in a second common plane (e.g., a second vertical plane) that is different from or spaced from the common plane (e.g., the first vertical plane) in which the intraplanar corners 310A-310D are positioned. Thus, the interplanar corners 312A and 312B are spaced laterally from the first common plane in which the intraplanar corners 310A-310D lie. An example implementation of the interplanar corners 312A, 312B is described below in conjunction with FIG. 5B.

Additionally, the flexible isolator 200 of the illustrated example includes an opening 317 to enable visual access between an external area of the flexible isolator 200 and an internal area of the flexible isolator 200. The opening 317 of the illustrated example is formed within the perimeter of the flexible isolator 200. Thus, the flexible isolator 200 of the illustrated example includes a thickness 319 defined between an outer perimeter edge 321A and an inner perimeter edge 321B.

FIG. 3B is a cross-sectional view of the flexible isolator 200 taken along the line 3B-3B of FIG. 3A. In the illustrated example of FIG. 3B, the bellows 306 is positioned between the first flange 302 and the second flange 304. The bellows 306 of the illustrated example include an example first crest 314A, an example second crest 314B, an example first root 316A, and an example second root 316B. In the illustrated example of FIG. 3B, the bellows 306 has an example first end 318A adjacent to the first flange 302 and an example second end 318B adjacent to the second flange 304. In the illustrated example of FIG. 3B, the first flange 302 includes an example first side 320A and an example second side 320B. In the illustrated example of FIG. 3B, the second flange 304 includes an example third side 320C (e.g., a first side of the second flange 304, etc.) and an example fourth side 320D (e.g., a second side of the second flange 304, etc.). In the illustrated example of FIG. 3B, the first side 320A of the first flange 302 is opposite the second side 320B of the first flange 302. In the illustrated example of FIG. 3B, the third side 320C of the second flange 304 is opposite the fourth side 320D of the second flange 304. In the illustrated example of FIG. 3A and 3B, the first flange 302 and the second flange 304 have a same thickness, which is uniform along the perimeter of the flexible isolator 200. In other examples, the first flange 302 and the second flange 304 can have different thickness(es), which can be variable along the length and/or perimeter of the flexible isolator 200. The coupling of the flanges 302, 304 to the panels 112A, 112B and the parent structure 202 is described below in greater detail in conjunction with FIG. 4.

The bellows 306 of the illustrated example extends between the first flange 302 and the second flange 304. In the illustrated example of FIG. 3B, the bellows 306 is corrugated. In other examples, the bellows 306 can be U-shaped, trapezoidal, half-circular, and/or triangular. In the illustrated example of FIG. 3B, the bellows 306 includes two convolutions. That is, the bellows 306 includes two crests (e.g., the crests 314A, 314B, etc.) and two roots (e.g., the roots 316A, 316B, etc.). In other examples, the bellows 306 can include any other suitable number of convolutions (e.g., a single convolution, three convolutions, ten convolutions, etc.). In the illustrated example of FIG. 3B, the configuration of the convolutions of the bellows 306 (e.g., a zig-zag configuration of the bellows 306, etc.) facilitates expansion and compression of the flexible isolator 200 between the panels 112A, 112B and the parent structure 202 and/or the bending of the flexible isolator 200 within the planes 204A, 204B. In the illustrated example of FIG. 3B, the bellows 306 has a uniform thickness. In other examples, the bellows 306 can have a non-uniform thickness profile (e.g., thicker near the first end 318A, thicker near the second end 318B, thicker near the crests 314A, 314B and roots 316A, 316B, etc.). In some examples, a spring rate of the bellows 306 can be tuned via an example thickness 322 of the bellows 306, a thickness profile of the bellows 306, a shape of the convolutions of the bellows 306 (e.g., a shape of the convolutions, a height of the convolutions, a pitch of the convolutions, etc.), and/or a number of convolutions of the bellows 306. The bellows 306 can be manufactured by coupling multiple strips of material (e.g., a metal, a composite, an elastomer, etc.) via folding, forming, welding, adhesive, additive manufacturing and/or any other suitable manufacturing process(es) and/or technique(s). In other examples, the bellows 306 can be an integral component that is shaped via bending, pressing, folding, etc. In some examples, if the bellows 306 is composed of a thermally conductive material and/or electrically conductive material (e.g., aluminum, copper, steel, etc.), the flexible isolator 200 can thermally conduct electricity and/or heat between the panels 112A, 112B and the parent structure 202.

In the illustrated example of FIGS. 3A and 3B, the bellows 306 does not include openings (e.g., between the outer perimeter edge 321A and the inner perimeter edge 321B, etc.). In some such examples, the bellows 306 is a seal (e.g., an environmental seal, etc.), which inhibits the flow of material (e.g., air, liquids, debris, etc.) through the flexible isolator 200. In other examples, the bellows 306 can include openings to facilitate the flow of material through the flexible isolator 200. Additionally or alternatively, the bellows 306 can be composed or formed of a permeable material (e.g., a mesh, etc.), which can similarly permit the flow of fluids and/or other material(s) through the bellows 306. Thus, in the illustrated example, the flexible isolator 200 has a shape that is complementary to the shape the panels 112A, 112B and/or the parent structure 202.

In the illustrated example of FIG. 3B, the first end 318A extends from and is coupled to second side 320B of the first flange 302 and the second end 318B extends from and is coupled to fourth side 320D of the second flange 304. In some examples, the first side 320A of the first flange 302 and the third side 320C of the second flange 304 can be coupled to panels (e.g., the panels 112A, 112B, etc.) of a panel assembly (e.g., the panel assembly 102), and a parent structure (e.g., the parent structure 202, etc.) of a panel assembly.

In the illustrated example of FIGS. 3A and 3B, the flexible isolator 200 is an integral component (e.g., composed of a unitary piece of material, etc.). In other examples, the flexible isolator 200 can be composed of multiple discrete segments. For example, the first flange 302, the second flange 304, and the bellows 306 can be discrete components, which are coupled via one or more suitable fasteners. In some examples, the first end 318A of the bellows 306 can be coupled to the first flange 302 via one or more fasteners, one or more welds, one or more chemical adhesives, and/or an interference fit. Additionally or alternatively, the second end 318B of the bellows 306 can be coupled to the second flange 304 via one or more fasteners, one or more welds, one or more chemical adhesives, and/or an interference fit.

FIG. 4 is a cross-sectional view of the panel assembly 102 taken along line 4-4 of FIG. 2. In the illustrated example of FIG. 4, the panel assembly 102 includes the flexible isolator 200, the first panel 112A, and the parent structure 202. In the illustrated example of FIG. 4, the parent structure 202 includes the example structure lip 211 and an example plate 402, which includes an example recessed portion 404. In the illustrated example of FIG. 2, the structure lip 211 includes an example tapered surface 406 and an example first outer surface 407. In the illustrated example of FIG. 4, the first panel 112A includes an example panel lip 408, an example second outer surface 409, and an example inner surface 410. While FIG. 4 is described with reference to the coupling of the first panel 112A and the parent structure 202, it should be appreciated the second panel 112B is also coupled to the parent structure 202 via the interface 208.

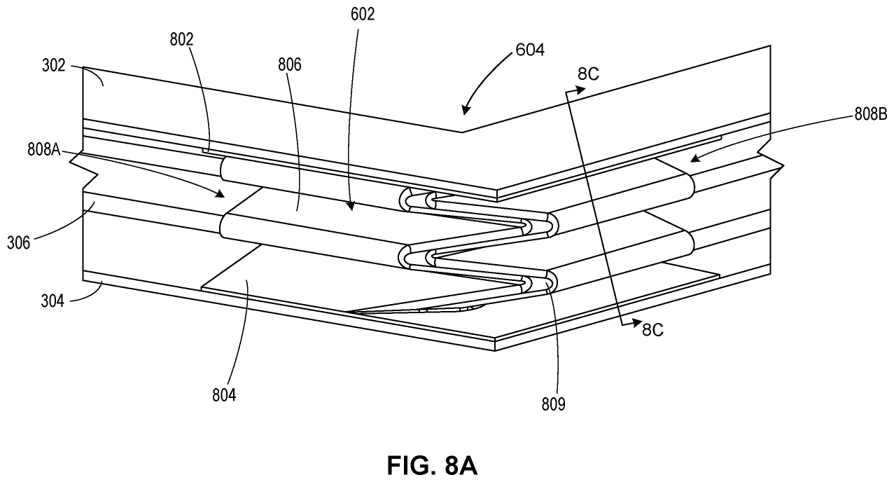

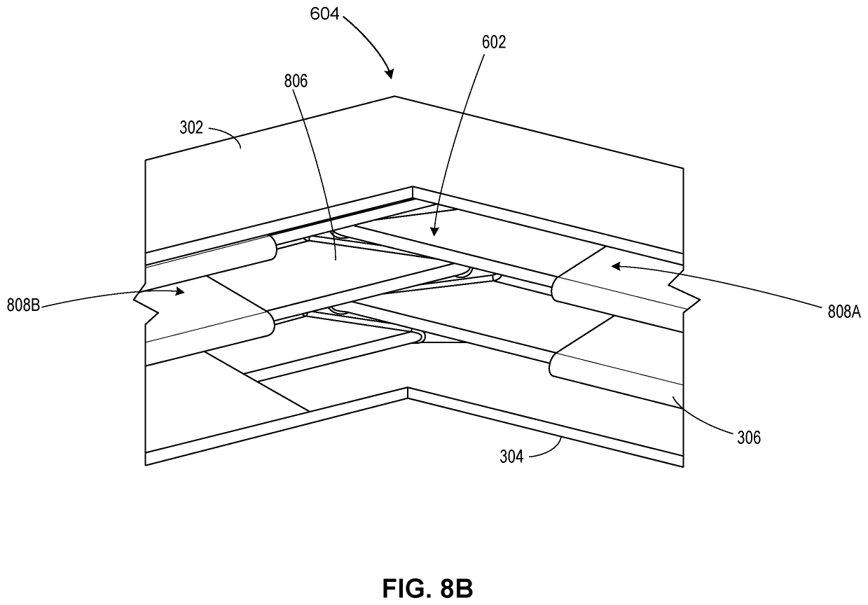

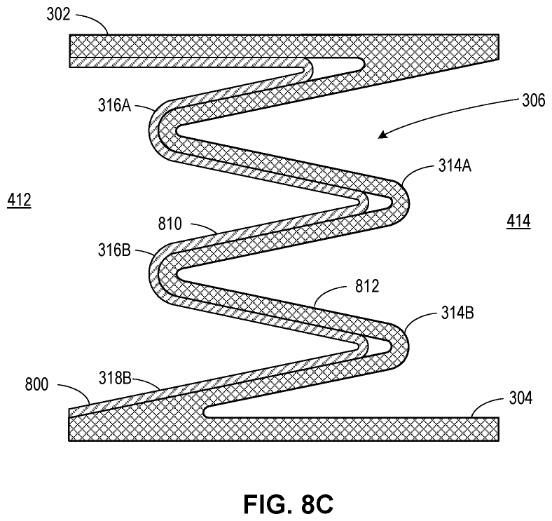

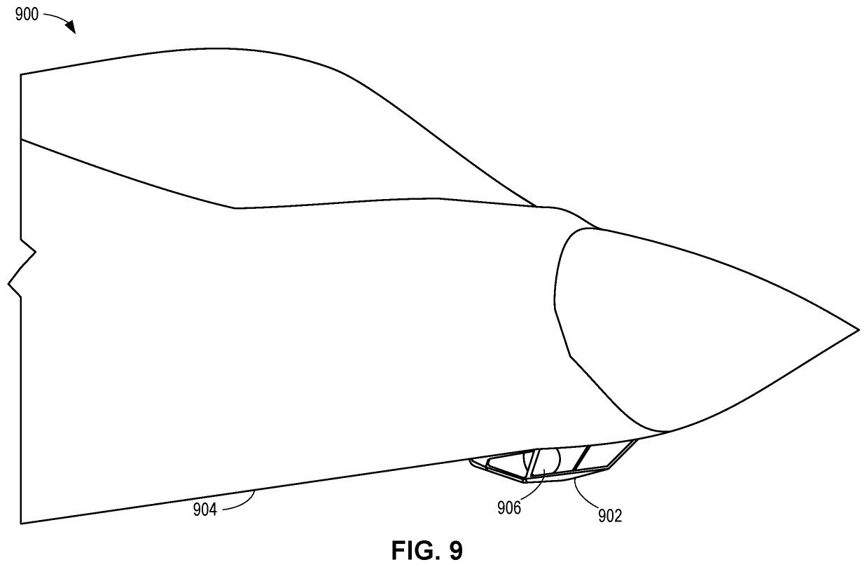

In the illustrated example of FIG. 4, the flexible isolator 200 separates an example interior volume 412 of the parent structure 202 from an exterior volume 414 (e.g., the ambient environment, etc.) on an exterior of the plate 402 of the parent structure 202. As described above in conjunction with FIGS. 2-3B, the bellows 306 functions as a seal, which prevents the flow of air, fluids, and/or debris between the exterior volume 414 and the interior volume 412. Additionally or alternatively, the interface 208 can include one or more additional and/or separate seal(s) that seals the interior volume 412 from the exterior volume 414. An example auxiliary seal that can be used in conjunction with the interface 208 is described below in conjunction with FIGS. 8A-8C.

In the illustrated example of FIG. 4, the first panel 112A is generally L-shaped (e.g., the panel lip 408 extends from the second outer surface 409 toward the plate 402, etc.). In other examples, the first panel 112A can have any other suitable shape (e.g., generally planar, T-shaped, U-shaped, etc.). In some such examples, the panel lip 408 is absent. That is, the flexible isolator 200 is compatible with a panel assembly of any shape and/or arrangement. In the illustrated example of FIG. 4, the parent structure 202 is generally L-shaped (e.g., the structure lip 211 extends from the plate 402, etc.)

The flexible isolator 200 extends between the first panel 112A and the parent structure 202. For example, the flexible isolator 200 of the illustrated example extends between the inner surface 410 of the panel 112A and the plate 402 of the parent structure 202. In the illustrated example of FIG. 4, the first side 320A of the first flange 302 is coupled to the first panel 112A (e.g., the inner surface 410 of the first panel 112A, etc.) and the third side 320C of the second flange 304 is coupled to the parent structure 202 (e.g., the recessed portion 404 of the plate 402 of the parent structure 202). In the illustrated example of FIG. 4, the recessed portion 404 enables the first outer surface 407 and the second outer surface 409 to be substantially flush when the bellows 306 is unstressed (e.g., not strained by a load transmitted via the interface 208, etc.). In other examples, the recessed portion 404 can be absent. In some such examples, the outer surfaces 407, 409 are not flush. In the illustrated example of FIG. 4, the structure lip 211 of the parent structure 202 includes the tapered surface 406. In other examples, the tapered surface 406 is absent.

During operation, vibrations generated by the parent structure 202 are damped via the flexible isolator 200. That is, vibration generated by the parent structure 202 is absorbed and/or dissipated by the bellows 306, which can prevent potential damage to the first panel 112A. Similarly, during operation, loads generated by the parent structure 202 (e.g., from thrust of a powerplant associated with the parent structure 202, from aero-effects associated with the parent structure 202, etc.) can cause deflection of the flexible isolator 200. That is, reflective deflection of the parent structure 202 toward the first panel 112A causes the compression of the bellows 306 (e.g., the inner surface 410 of the first panel 112A is relatively displaced toward the plate 402, etc.). Similarly, the relative deflection of the parent structure 202 away from the first panel 112A causes the expansion of the bellows 306 (e.g., the inner surface 410 of the first panel 112A is relatively displaced away the plate 402, etc.) In the illustrated example of FIG. 4, the first panel 112A has an example distance 415 from the structure lip 211 of the parent structure 202. In some examples, the distance 415 facilitates the displacement of the first panel 112A toward the structure lip 211 and away from the structure lip 211 (e.g., via the deformation of the flexible isolator 200, etc.). By tuning a spring rate of the bellows 306 of the flexible isolator 200, stiffness and/or displacement behavior or characteristics of the flexible isolator 200 can be tuned or adjusted based on aviation systems associated with the panel assembly 102.

FIG. 5A is a perspective, partial view of an example first corner 500 of the flexible isolator 200 of FIGS. 2-4. For example, the first corner 500 can correspond to one of the intraplanar corners of FIG. 3A (e.g., one of the intraplanar corners 310A, 310B, 310C, 310D of FIG. 3A, etc.). In the illustrated example of FIG. 5A, the first corner 500 includes an example first joint 502 in the bellows 306 between an example first side 504 and an example second side 506. In the illustrated example of FIG. 5A, on the first side 504, the bellows 306 includes an example first crest 508A and an example second crest 508B, which correspond to the crests 314A, 314B of FIG. 3A, respectively. In the illustrated example of FIG. 5A, on the second side 506, the bellows 306 includes an example third crest 508C and an example fourth crest 508D, which also correspond to the crests 314A, 314B of FIG. 3A, respectively. In the illustrated example of FIG. 5A, an example first outer edge portion 510A extends between the first crest 508A and the third crest 508C, an example second outer edge portion 510B extends between the first crest 508A and the fourth crest 508D, and an example third outer edge portion 510C extends between the second crest 508B and the fourth crest 508D. In the illustrated example of FIG. 5A, the outer edge portions 510A, 510B, 510C are not parallel. That is, the first crest 508A is not aligned with the second crest 508B and the third crest 508C is not aligned with the fourth crest 508D. In the illustrated example of FIG. 5A, the joint 502 has generally the same shape as the cross-section of the bellows depicted in FIG. 3B.

FIG. 5B is a perspective view of an example second corner 512 of the flexible isolator 200 of FIGS. 2-4. For example, the second corner 512 can correspond to one of the intraplanar corners of FIG. 3B (e.g., one of the interplanar corners 312A, 312B of FIG. 3B, etc.). In the illustrated example of FIG. 5B, the second corner 512 is formed at the joint 308 of FIG. 3A (e.g., at an interface between the first panel 112A and the second panel 112B, etc.). In the illustrated example of FIG. 5B, the bellows 306 includes an example second joint 514 between an example third side 516 and an example fourth side 518. In the illustrated example of FIG. 5B, on the third side 516, the bellows 306 includes an example first crest 520A and an example second crest 520B, which correspond to the crests 314A, 314B of FIG. 3A, respectively. In the illustrated example of FIG. 5B, on the fourth side 518, the bellows 306 includes an example third crest 520C and an example fourth crest 520D, which also correspond to the crests 314A, 314B of FIG. 3A, respectively. In the illustrated example of FIG. 5B, unlike in the first corner 500 of FIG. 5A, the first crest 520A is contiguous and aligned with the third crest 520C (e.g., the first crest 520A directly intersects with and continues as the third crest 520C at the joint 514, etc.) and the second crest 520B is contiguous and aligned with the fourth crest 520D (e.g., the second crest 520B directly intersects with and continues as the fourth crest 520D at the joint 514, etc.). In other words, the joint 514 provides a transition between the first crest 520A and the third crest 520C so that the first crest 520A is continuous with and/or aligns with the third crest 520C. The joint 514 provides a transition between the second crest 520B and the fourth crest 520D so that the second crest 520B is continuous with and/or aligns with the fourth crest 520D.

FIG. 6A is a partial, perspective view of the flexible isolator 200 of FIGS. 2-4 including an example first spring 600 disclosed herein. The flexible isolator 200 and the example first spring 600 are configured in an example first configuration 601. In the illustrated example, the first spring 600 is disposed in an example opening 602 of the flexible isolator 200 of FIGS. 2-4. In the first configuration 601, the first spring 600 is disposed in an example corner 604 of the flexible isolator 200. In the illustrated example of FIG. 6A, the first spring 600 includes an example first mounting boss 606A, an example second mounting boss 606B, an example first arm 608A, and an example second arm 608B. In the illustrated example of FIG. 6A, the first mounting boss 606A includes an example first hole 610A and the second mounting boss 606B includes an example second hole 610B. In the illustrated example of FIG. 6A, the first spring 600 includes an example opening 612.

The first spring 600 is a spring and damper that is disposed between the first flange 302 and the second flange 304. In the illustrated example of FIG. 6A, each of the arms 608A, 608B extends (e.g., in a direction away) from the mounting bosses 606A, 606B. The first spring 600 can be used to modify or adjust (e.g., increase) a stiffness of the flexible isolator 200 (e.g., adjacent or at the corner 604). For example, the first spring 600 can be employed to increase the stiffness of the flexible isolator 200 adjacent or at the corner 604 when compared to the bellows 306, decrease a stiffness of the flexible isolator 200 adjacent or at the corner when compared to the bellows 306, etc. In some examples, a thickness of the arms 608A, 608B, a size of the opening 612, and/or a geometry of the opening 612 can be modified to tune the stiffness and/or vibration damping of the flexible isolator 200. For example, increasing a thickness of the arms 608A, 608B (e.g., decreasing the thickness of the opening 612, etc.) can increase a stiffness of the flexible isolator 200 (e.g., adjacent or at the corner 604).

In the illustrated example of FIG. 6A, the first spring 600 is generally L-shaped. In other examples, the first spring 600 can have any other suitable shape (e.g., depending on a shape of the opening 602, depending on a geometry of the flanges 302, 304, etc.) In the illustrated example of FIG. 6A, the first spring 600 is coupled to the second side 320B of the first flange 302 via the first mounting boss 606A and the fourth side 320D of the second flange 304 via the second mounting boss 606B. For example, one or more fastener(s) (e.g., a bolt, a rivet, a screw, a pin, etc.) can be disposed in or received by the holes 610A, 610B and corresponding holes formed in the flanges 302, 304, a panel coupled to the first flange 302 (e.g., one of the panels 112A, 112B of FIGS. 1-2, etc.), a parent structure (e.g., the parent structure 202 of FIG. 2, etc.) and/or any other frame or intervening structure or layer. Additionally or alternatively, the mounting bosses 606A, 606B can be coupled to the flanges 302, 304, respectively, via one or more welds, one or more chemical adhesives, one or more interference fits, etc. In some examples, the mounting bosses 606A, 606B can be integrally formed with the flanges 302, 304, respectively. In the illustrated example of FIG. 6A, the mounting bosses 606A, 606B are disposed at the corner 604. In other examples, the mounting bosses 606A, 606B can be displaced from the corner 604. In some such examples, the mounting bosses 606A, 606B are absent and the first spring 600 couples to the flexible isolator 200 via the arms 608A, 608B.

In the illustrated example of FIG. 6A, the opening 602 is formed in the bellows 306 between the flanges 302, 304. That is, the flexible isolator 200 does not include bellows 306 in the opening 602 adjacent or at the first corner 604. The first corner 604 can correspond to one of intraplanar corners of the flexible isolator 200 (e.g., one of the intraplanar corners 310A, 310B, 310C, 310D of FIG. 3A, one of the interplanar corners 312A, 312B, etc.). In other examples, the first spring 600 can be disposed along a straight segment or a non-corner location of the flexible isolator 200 (e.g., along a segment of the flexible isolator 200 between one or more of the corners 310A, 310B, 310C, 310D, 312A, 312B of FIG. 3A, etc.). In some such examples, the first spring 600 can have a complementary shape with the opening 602 (e.g., linearly shaped for straight segments, etc.).

FIG. 6B is a partial, perspective view of the flexible isolator 200 of FIG. 2 and the first spring 600 of FIG. 6A in an example second configuration 614. In the second configuration 614, the first spring 600 is disposed in an example second corner 616 of the flexible isolator 200. In the illustrated example of FIG. 6B, the first mounting boss 606A of the first spring 600 is coupled to the third side 320C of the second flange 304. In some examples, the second mounting boss 606B of the first spring 600 can be coupled to the parent structure associated with the panel assembly 102. For example, the first spring 600 can be disposed within an opening (e.g., a beveled region, a hole, etc.) formed in the parent structure (e.g., the parent structure 202 of FIGS. 2 and 4, etc.). In some such examples, the second mounting boss 606B can be coupled to the recessed portion 404 of FIG. 4. Similar to the first configuration 601 of FIG. 6A, in the second configuration 614, a thickness, shape and/or size of the opening 612 in the first spring 600 can be selected to adjust or tune (e.g., increase, decrease, etc.) the damping and/or stiffness of the flexible isolator 200 at the second corner 616.

FIG. 6C is a partial, perspective view of the flexible isolator 200 of FIG. 2 and the first spring 600 of FIGS. 6A and 6B in an example third configuration 618. In the third configuration 618, the first spring 600 is disposed in an example corner 620 of the flexible isolator 200. In the illustrated example of FIG. 6C, the first spring 600 extends (e.g., or is positioned) between the first flange 302 and the second flange 304. In the illustrated example of FIG. 6C, the first mounting boss 606A of the first spring 600 is coupled to the second side 320B of the first flange 302 and the second mounting boss 606B is coupled to the fourth side 320D of the second flange 304. Unlike the first configuration 601 of FIG. 6A, the first spring 600 is not disposed in or adjacent an opening in the bellows 306. Instead, the first spring 600 is disposed next to the bellows 306. In the third configuration 618, the bellows 306 does not have an opening (e.g., the opening 602). Similar to the first configuration 601 of FIG. 6A and the second configuration 614 of FIG. 6B, in the third configuration 618, a thickness, shape and/or size of the opening 612 in the first spring 600 can be selected to adjust or tune (e.g., increase, decrease, etc.) the damping and/or stiffness of the flexible isolator 200 (e.g., adjacent or at the third corner 620).

FIG. 7A is a partial, perspective view of the flexible isolator 200 of FIGS. 2-4 and an example second spring 700 disclosed herein. The second spring 700 of the illustrated example is disposed in the opening 602 of FIG. 6A similar to the first configuration 601 of FIG. 6A. The second spring 700 of the illustrated example is a coil spring (e.g., a helical spring, etc.). In other examples, the second spring 700 can be implemented by more than one coil spring, one or more volute spring(s), one or more bow spring(s), one or more flat spring(s), one or more air spring(s), one or more leaf spring(s), one or more disc spring(s), one or more Belleville springs, etc. In the illustrated example of FIG. 7A, the second spring 700 extends (e.g., is positioned) between the first flange 302 and the second flange 304. That is, the second spring 700 is coupled to or engages the second side 320B of the first flange 302 and the fourth side 320D of the second flange 304. Thus, the first flange 302 and the second flange 304 provide respective spring seats for the second spring 700. The second spring 700 can be used to modify (e.g., adjust, increase, decrease, etc.) a stiffness of the flexible isolator 200 (e.g., adjacent or at the corner 604). For example, the second spring 700 can be sued to increase the stiffness of the flexible isolator 200 adjacent or at the corner 604 when compared to the bellows 306, decrease a stiffness of the flexible isolator 200 adjacent or at the corner when compared to the bellows 306, etc.). In some examples, a thickness of example coils 702 of the second spring 700, a number of the coils 702, a geometry of the coils 702, a spring rate of the second spring 700, and/or a length of the second spring 700 can be modified to adjust or tune (e.g., increase, decrease, etc.) a stiffness and/or vibration damping of the flexible isolator 200. For example, increasing a thickness and/or a number of the coils 702 (e.g., decreasing the thickness of the opening 612, etc.) can increase a stiffness of the flexible isolator 200 (e.g., adjacent or at the corner 604).

FIG. 7B is a partial, perspective view of the flexible isolator 200 of FIG. 2 and the second spring 700 of FIG. 7A in an example second configuration 614. In the second configuration 614, the second spring 700 is disposed adjacent or at the second corner 616 of the flexible isolator 200. In the illustrated example of FIG. 6B, the second spring 700 is coupled to the third side 320C of the second flange 304. For example, the second spring 700 can be supported by, and/or disposed within an opening (e.g., a beveled region, a hole, etc.) formed in, the parent structure (e.g., the parent structure 202 of FIGS. 2 and 4, etc.). Similar to the first configuration 601 of FIG. 7A, in the second configuration 614, a thickness of example coils 702 of the second spring 700, a number of the coils 702, a geometry of the coils 702, a length of the second spring 700, a spring rate of the second spring 700 can be selected to adjust or tune (e.g., increase, decrease) the damping and/or stiffness of the flexible isolator 200 at the second corner 616.

FIG. 7C is a partial, perspective view of the flexible isolator 200 of FIG. 2 and the first spring 700 of FIGS. 7A and 7B in the third configuration 618 of FIG. 6C. In the third configuration 618, the first spring 700 is disposed at the third corner 620 of the flexible isolator 200. In the illustrated example of FIG. 7C, the second spring 700 extends between the first flange 302 and the second flange 304. Thus, the first flange 302 and the second flange 304 provide. Unlike the first configuration 601 of FIG. 7A, the second spring 700 is not disposed in an opening in the bellows 306 and is disposed next to the bellows 306. Thus, the bellows 306 does not include an opening. Similar to the first configuration 601 of FIG. 7A and the second configuration 614 of FIG. 7B, in the third configuration 618, a thickness of example coils 702 of the second spring 700, a number of the coils 702, a geometry of the coils 702, a length of the second spring 700, and/or a spring rate of the second spring 700 can be selected to adjust or tune (e.g., increase or decrease) the damping and/or stiffness of the flexible isolator 200 adjacent or at the second corner 616.

FIG. 8A is a partial, exterior perspective view of the example flexible isolator 200 of FIG. 2 implemented with an example auxiliary seal 800 disclosed herein. The auxiliary seal 800 of the illustrated example is positioned or disposed adjacent or at the first corner 604 of FIGS. 6A and 7A. For example, the auxiliary seal 800 of the illustrated example covers and/or seals (e.g. fluidly seals) the opening 602 of the flexible isolator 200 of FIG. 6A. FIG. 8B is a partial, interior perspective view of the flexible isolator 200 and the auxiliary seal 800 of FIG. 8B. Referring to FIGS. 8A and 8B, the auxiliary seal 800 of the illustrated example includes an example first seal flange 802, an example second seal flange 804, and example seal bellows 806. In the illustrated example of FIGS. 8A and 8B, the auxiliary seal 800 includes an example first seal end 808A and an example second seal end 808B.

In the illustrated example of FIGS. 8A-8B, the auxiliary seal 800 extends (e.g., positioned vertically) between the first flange 302 and the second flange 804. The example first seal flange 802 is coupled to the flange 302 and the example second seal flange 804 is coupled to the second flange 804. The first seal end 808A and the second seal end 808B of the illustrated example are coupled the bellows 306. That is, the auxiliary seal 800 extends over and/or completely covers the opening 602 (FIG. 6A) in the bellows 306. In the illustrated example of FIG. 8A, the auxiliary seal 800 includes an example seal joint 809 at the corner 604. In the illustrated example of FIG. 8A, because the corner 604 is an intraplanar corner (e.g., one of the corners 310A, 310B, 310C, 310C of FIG. 3A, etc.), the seal joint 802 is similar to the joint 502 of FIG. 5A. In other examples, if an auxiliary seal is coupled to a corner that is an interplanar corner (e.g., one of the corners 312A, 312B of FIG. 3A, etc.), the seal joint 802 can be similar to the joint 514 of FIG. 5B. In other examples, if the opening 602 is disposed at a non-corner location of the flexible isolator 200, the seal joint 809 is absent.

The auxiliary seal 800 inhibits (e.g., prevents, reduces, etc.) the flow of fluids, debris, and/or other materials through the opening 602. Unlike the bellows 306 of the flexible isolator 200, the auxiliary seal 800 does not substantially increase a stiffness of the flexible isolator 200 (e.g., at or near the opening 602 or the corner 604). As such, the example auxiliary seal 800 disclosed herein can enable example flexible isolators disclosed herein to employ openings (e.g., the opening 602) located at one or more locations along the flexible isolator 200 to adjust or tune a stiffness and/or damping of the flexible isolator 200 without compromising a sealing function of the flexible isolator 200. While one auxiliary seal 800 is depicted in the illustrated examples of FIGS. 8A-8B, it should be appreciated the flexible isolator 200 can include any suitable number of similar seals (e.g., a seal in each gap formed in the bellows 306, etc.). The auxiliary seal 800 can be composed of any compliant flexible material, such as an elastomer (e.g., natural rubber, synthetic rubber, a thermoplastic elastomer, etc.) and/or any other suitable material (e.g., a flexible mesh, one or more natural fibers, one or more flexible plastics, etc.). FIG. 8C is a cross-sectional view of the flexible isolator 200 and the auxiliary seal 800 taken along line 8C-8C of FIG. 8A. In the illustrated example of FIG. 8C, the flexible isolator 200 includes an example first surface 810 that extends (e.g., continuously) along at least a portion of the first flange 302, the bellows 306, and the second flange 304. In the illustrated example, the auxiliary seal 800 faces the interior volume 412 of FIG. 4. In the illustrated example of FIG. 8C, the flexible isolator 200 defines an example second surface 812 that extends (e.g., continuously) along at least a portion of the first flange 302, the bellows 306, and the second flange 304, and faces the interior volume 414 of FIG. 4. In some examples, the auxiliary seal 800 is complementary to a shape of the first surface 810 of the flexible isolator 200.

In the illustrated example of FIGS. 8C, the auxiliary seal 800 is coupled to the first surface 810. In the illustrated example of FIG. 8C, the auxiliary seal 800 extends over the roots 316A, 316B and extends into the crests 314A, 314B. In some examples, the auxiliary seal 800 can be coupled to the first surface 810 via one or more chemical adhesives, one or more mechanical fasteners, and/or any other suitable fastening method. In some examples, an additional seal can be coupled to the second side 812 to bolster the seal provided by the auxiliary seal 800. In some examples, the auxiliary seal 800 can be integrally formed with the flexible isolator 200 via injection molding, three-dimensional printing, welding, and/or any other manufacturing techniques.

FIG. 9 is a perspective, partial view of an example aircraft 900 including an example multi-panel assembly 902 disclosed herein. In the illustrated example of FIG. 9, the aircraft 900 is an aviation system and includes an example body 904. In the illustrated example of FIG. 9, the multi-panel assembly 902 houses an example sensor 906. In some examples, the sensor 906 and the multi-panel assembly 902 can be components of an electro-optical targeting system (EOTS). The multi-panel assembly 902 can be coupled to the body 904 via a flexible isolator similar to the flexible isolator 200 described in conjunction with FIGS. 2A-4, which (1) damps vibrations transmitted between body 904 and the multi-panel assembly 902, (2) environmental seals the interior of the multi-panel assembly 902 (e.g., the sensor, etc.), and (3) permits the relative displacement of the multi-panel assembly 902 from the body 904. In the illustrated example of FIG. 9, the multi-panel assembly 902 includes 9 panels (e.g., windowpanes, windows, window panels, etc.), which permit optical signals to be received by the sensor 906. In other words, the isolator permits optical signals to pass therethrough and does not interfere or reduce a strength of the signals. In other examples, the multi-panel assembly 902 can include any other suitable number of panels. In some examples, the multi-panel assembly 902 can include the first spring 600 in one or more of the configuration(s) of FIGS. 6A-6C, the second spring 700 in one or more of the configuration(s) of FIGS. 7A-7C, and/or the auxiliary seal 800 of FIGS. 8A-8C.

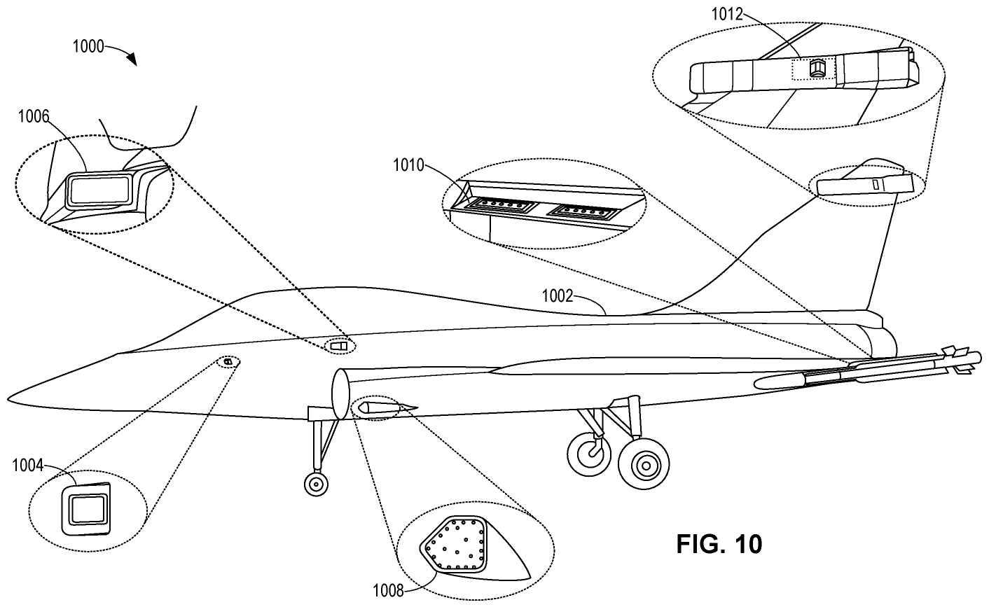

FIG. 10 is a perspective view of an example aircraft 1000 including a plurality of example panel assemblies disclosed herein. In the illustrated example of FIG. 10, the aircraft 1000 is an aviation system and includes an example body 1002. In the illustrated example of FIG. 10, the aircraft 1000 includes an example first panel assembly 1004, an example second panel assembly 1006, an example third panel assembly 1008, an example fourth panel assembly 1010, and an example fifth panel assembly 1012. In the illustrated example of FIG. 10, each of the panel assemblies 1004, 1006, 1008, 1010, 1012 is a single panel assembly. In other examples, some or all of the panel assemblies 1004, 1006, 1008, 1010, 1012 can have more than one panel (e.g., two panels, three panels, four panels, etc.). In the illustrated example of FIG. 10, the panel assemblies 1004, 1006, 1008, 1010, 1012 are electrical panels. In some examples, the component(s) of the panel assemblies 1004, 1006, 1008, 1010, 1012 can be sensitive to loading and/or vibration from the body 1002. In some examples, some or all of the panel assemblies 1004, 1006, 1008, 1010, 1012 are coupled to the body 1002 via a flexible isolator similar to the flexible isolator 200 described in conjunction with FIGS. 2A-4, which (1) damps vibrations transmitted between body 1002 and corresponding ones of the panel assemblies 1004, 1006, 1008, 1010, 1012, (2) environmental seals interior of the components of the panel assemblies 1004, 1006, 1008, 1010, 1012, and (3) permits relative displacement of the panel assemblies 1004, 1006, 1008, 1010, 1012 from the body 1002. For example, the first panel assembly 1004 is an electrical panel including a jammer (e.g., a radar jammer, etc.), the second panel assembly 1006 is an electrical panel including a laser warning receiver (LWR), the third panel assembly 1008 is an electrical panel including a radar warning receiver (RWR), the fourth panel assembly 1010 is an electrical panel that controls countermeasures (e.g., chaff, etc.) from the aircraft 1000, and the fifth panel assembly 1012 is an electrical panel including an infrared sensor and a missile detection system. In other examples, the panel assemblies 1004, 1006, 1008, 1010, 1012 can include any other suitable components. In some examples, some or all of the panel assemblies 1004, 1006, 1008, 1010, 1012 can include the first spring 600 in one or more of the configuration(s) of FIGS. 6A-6C, the second spring 700 in one or more of the configuration(s) of FIGS. 7A-7C, and/or the auxiliary seal of FIGS. 8A-8C.

While examples disclosed herein are described with reference to aviation systems (e.g., the aviation system 100 of FIG. 1, the aircraft 900 of FIG. 9, the aircraft 1000 of FIG. 10, etc.), the teachings of this disclosure are not limited to such aviation systems. Instead, the panel assembly 102 of FIGS. 1 and 2 and the flexible isolator 200 of FIG. 2 can be used in conjunction with any other assembly that includes panels with vibration and deflection-sensitive components. For example, the isolators and panel assemblies disclosed herein can be used in conjunction with other vehicles (e.g., nautical vehicles, automobiles, trains, construction vehicles, etc.), precision industrial machinery (e.g., computer numerical control (CNC) machines, additive manufacturing machines, etc.), laboratory equipment (e.g., microscopes, lasers, high-power magnets, etc.) and/or any other sensitive machinery.

It should be appreciated that the panel assembly 102 of FIGS. 1 and 2 and the flexible isolator 200 of FIG. 2 dampen vibrations associated with aviation systems, such as the aviation system 100 of FIG. 1. For example, operations to assemble an aviation system including the panel assembly 102 of FIGS. 1 and 2 and the flexible isolator 200 of FIG. 2 and/or dampen vibrations generated by the aviation system include manufacturing the flexible isolator 200. For example, the flexible isolator 200 of FIG. 2 can be manufactured by bending, pressing, folding, etc. Additionally or alternatively, the flexible isolator 200 can be manufactured via additive manufacturing. After the manufacturing of the flexible isolator 200, the panels 112A, 112B can be coupled to the first flange 302 via one or more weld(s), one or more fastener(s), one or more interference fit(s), and/or one or more chemical adhesive(s) to form the panel assembly 102. The panel assembly 102 can be coupled to the parent structure 202 by coupling the second flange 304 to the parent structure via one or more weld(s), one or more fastener(s), one or more interface fit(s), and/or one or more chemical adhesive(s). The coupling of the panel assembly 102 to the parent structure 202 enables the flexible isolator 200 to damped (e.g., damp, reduce vibration, etc.) transmitted between the parent structure 202 and the panels 112A, 112B. For example, a method of assembling a panel assembly 102 to dampen vibrations between two structures (e.g., of an aviation system) includes attaching a first flange 302 of the panel assembly 102 to a first structure and attaching a second flange 304 of the panel assembly 102 to a second structure to position a flexible isolator 200 of the panel assembly 102 between the first structure and the second structure. The flexible isolator 200 of the panel assembly 102 is structured to enable the first structure to move relative to the second structure. The flexible isolator 200 includes a plurality of bellows structured to enable the first structure to move relative to the second structure. In some examples, only the first structure moves relative to the second structure. In some examples, only the second structure moves relative to the first structure. In some examples, both the first structure and the second structure move relative to each other. The foregoing examples of the isolators and/or panel assemblies disclosed herein can be employed with aerospace systems, aviation systems, satellites, aircraft, automobiles, vehicles, structures, buildings, electrical panels, and/or any other system(s) that can benefit from vibration dampening and/or sealing. Although each of the example aviation systems, flexible isolators, panel assemblies, first spring 600, second spring 700, and/or the auxiliary seal 800 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example isolators for panel assemblies and other structures are disclosed herein. Further examples and combinations thereof include the following:

Example 1 includes an apparatus to be coupled to an aviation system, the apparatus including a panel, a frame, and an isolator coupling the panel and the frame, the isolator including a first flange including a first side coupled to the panel, and a second side opposite the first side, a second flange including a third side coupled to the frame, and a fourth side opposite the third side, and a flexible bellows positioned between the first flange and the second flange, the flexible bellows including a first end coupled to the second side, and a second end coupled to the fourth side.

Example 2 includes the apparatus of any preceding example, wherein the flexible bellows includes at least 2 convolutions.

Example 3 includes the apparatus of any preceding example, wherein the panel is at least one of a window or an electrical panel.

Example 4 includes the apparatus of any preceding example, wherein the panel is a first panel, and further including a multi-panel assembly including the first panel, and a second panel coupled to the first panel.

Example 5 includes the apparatus of any preceding example, wherein the first panel is disposed in a first plane, and the second panel is disposed in a second plane different than the first plane.

Example 6 includes the apparatus of any preceding example, wherein the first panel and the second panel define an interior perimeter, the first flange coupled to the interior perimeter.

Example 7 includes the apparatus of any preceding example, wherein the frame includes a plate coupled to the second flange of the isolator, and a lip extending from the plate.

Example 8 includes the apparatus of any preceding example, wherein the flexible bellows, the first flange, and the second flange are integral.

Example 9 includes the apparatus of any preceding example, wherein the flexible bellows seals an exterior volume of the panel from an interior volume of the frame.

Example 10 includes the apparatus of any preceding example, wherein the isolator further includes a spring disposed adjacent to a corner of the panel.

Example 11 includes the apparatus of any preceding example, wherein the spring extends between the first flange and the second flange.

Example 12 includes the apparatus of any preceding example, wherein the spring is disposed in an opening of the flexible bellows.

Example 13 includes an aviation system comprising a powerplant, a panel, a structure, and an isolator to isolate the panel from the powerplant, the isolator disposed between the panel and the structure a first flange coupled to the panel, a second flange coupled to the structure, and a flexible bellows having a first end extending from the first flange and a second end extending from the second flange.

Example 14 includes the aviation system of any preceding example, wherein the panel is a first panel, and further including a multi-panel assembly including the first panel, and a second panel joined to the first panel via a joint.

Example 15 includes the aviation system of any preceding example, wherein the first panel is positioned at an angle relative to the second panel.

Example 16 includes the aviation system of any preceding example, wherein the joint is a first joint and the isolator includes a second joint abutting the first joint.

Example 17 includes a flexible isolator to couple and isolate a panel and a frame, the flexible isolator including a first flange including a first portion disposed in a first plane, a second portion disposed in a second plane different than the first plane, and a joint disposed between the first portion and the second portion, a second flange, and a flexible bellows extending between the first flange and the second flange.

Example 18 includes the flexible isolator of any preceding example, wherein the joint is a first joint, the first portion includes a corner disposed within the first plane and the flexible bellows includes a first crest on a first side of the corner, a second crest on the first side of the corner, a third crest on a second side of the corner, a second joint disposed at the corner, the second joint including a first edge portion extending between the first crest and the third crest, and a second edge portion extending between the second crest and the third crest.

Example 19 includes the flexible isolator of any preceding example, wherein the corner is a first corner and the flexible bellows further includes a fourth crest on a third side of a second corner, and a fifth crest on a fourth side of the second corner, the fourth crest contiguous with the fifth crest.

Example 20 includes the flexible isolator of any preceding example, wherein the joint defines an internal angle of less than 180 degrees.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to be coupled to an aviation system, the apparatus including:
a panel;
a frame; and
an isolator coupling the panel and the frame, the isolator including:
a first flange including:
a first side coupled to the panel; and
a second side opposite the first side;
a second flange including:
a third side coupled to the frame; and
a fourth side opposite the third side; and
a flexible bellows positioned between the first flange and the second flange,
the flexible bellows including:
a first end coupled to the second side; and
a second end coupled to the fourth side.

2. The apparatus of claim 1, wherein the flexible bellows includes at least 2 convolutions.

3. The apparatus of claim 1, wherein the panel is at least one of a window or an electrical panel.

4. The apparatus of claim 1, wherein the panel is a first panel, and further including a multi- panel assembly including:
the first panel; and
a second panel coupled to the first panel.

5. The apparatus of claim 4, wherein the first panel is disposed in a first plane, and the second panel is disposed in a second plane different than the first plane.

6. The apparatus of claim 5, wherein the first panel and the second panel define an interior perimeter, the first flange coupled to the interior perimeter.

7. The apparatus of claim 1, wherein the frame includes:
a plate coupled to the second flange of the isolator; and
a lip extending from the plate.

8. The apparatus of claim 1, wherein the flexible bellows, the first flange, and the second flange are integral.

9. The apparatus of claim 1, wherein the flexible bellows seals an exterior volume of the panel from an interior volume of the frame.

10. The apparatus of claim 1, wherein the isolator further includes a spring disposed adjacent to a corner of the panel.

11. The apparatus of claim 10, wherein the spring extends between the first flange and the second flange.

12. The apparatus of claim 10, wherein the spring is disposed in an opening of the flexible bellows.

13. An aviation system comprising:
a powerplant;
a panel;
a structure; and
an isolator to isolate the panel from the powerplant, the isolator disposed between the panel and the structure:
a first flange coupled to the panel;
a second flange coupled to the structure; and
a flexible bellows having a first end extending from the first flange and a second end extending from the second flange.

14. The aviation system of claim 13, wherein the panel is a first panel, and further including a multi-panel assembly including:
the first panel; and
a second panel joined to the first panel via a joint.

15. The aviation system of claim 14, wherein the first panel is positioned at an angle relative to the second panel.

16. The aviation system of claim 14, wherein the joint is a first joint and the isolator includes a second joint abutting the first joint.

17. A flexible isolator to couple and isolate a panel and a frame, the flexible isolator including:
a first flange including:
a first portion disposed in a first plane;
a second portion disposed in a second plane different than the first plane; and
a joint disposed between the first portion and the second portion;
a second flange; and
a flexible bellows extending between the first flange and the second flange.

18. The flexible isolator of claim 17, wherein the joint is a first joint, the first portion includes a corner disposed within the first plane and the flexible bellows includes:
a first crest on a first side of the corner;
a second crest on the first side of the corner;
a third crest on a second side of the corner;
a second joint disposed at the corner, the second joint including:
a first edge portion extending between the first crest and the third crest; and
a second edge portion extending between the second crest and the third crest.

19. The flexible isolator of claim 18, wherein the corner is a first corner and the flexible bellows further includes:
a fourth crest on a third side of a second corner; and
a fifth crest on a fourth side of the second corner, the fourth crest contiguous with the fifth crest.

20. The flexible isolator of claim 17, wherein the joint defines an internal angle of less than 180 degrees.
